(19) United States
(12) Patent Application Publication
(10) Pub. No.: US 2026/0180015 A1
(43) Pub. Date: Jun. 25, 2026

(54) METHOD FOR MANUFACTURING AN ELECTROCHEMICAL CELL OF A POLYMER MATRIX BATTERY

(71) Applicant: PELLENC ENERGY, Pertuis (FR)

(72) Inventors: Jean-Louis FERRANDIS, La Motte d'Aigues (FR); Roger PELLENC, Pertuis (FR)

(73) Assignee: PELLENC ENERGY, Pertuis (FR)

(21) Appl. No.: 19/126,736

(22) PCT Filed: Nov. 3, 2023
(86) PCT No.: PCT/FR2023/051725

§ 371 Date: May 2, 2025

(30) Foreign Application Priority Data
Nov. 3, 2022 (FR) FR2211453

(51) Int. Cl. H01M 10/0525; H01M 4/134

(52) U.S. Cl. CPC H01M 10/0525; H01M 4/134

(57) ABSTRACT

A method for manufacturing an electrochemical cell of a polymer matrix battery includes covering an anode current collector film with an anode mixture which contains an anode active material dispersed in a first cross-linkable liquid electrolyte containing a first cross-linkable composition, forming an anode electrode, covering a cathode current collector film with a cathode mixture which contains a cathode active material dispersed in a second cross-linkable liquid electrolyte containing a second cross-linkable composition, forming a cathode electrode, stacking the anode electrode and the cathode electrode with the interposition of a separator film, electrically insulating, porous and impregnated with a third cross-linkable liquid or semi-liquid electrolyte, forming a stack, and exposing the stack to at least one electron beam so that the first cross-linkable liquid electrolyte and the second cross-linkable liquid electrolyte solidify in bulk, thereby forming the electrochemical cell.

### TECHNICAL FIELD

The invention relates to a method for manufacturing an electrochemical cell of a battery, as well as to an associated installation for manufacturing an electrochemical cell of a battery.

The invention finds a preferred application for manufacturing electrochemical cells of a polymer matrix battery, which can be used, without limitation, in fields as varied as portable electrical devices such as tools and communication equipment, electric vehicles, whether rolling, flying or floating, or stationary electrical energy storage installations.

### PRIOR ART

In a known manner, an electrochemical cell of a battery comprises an anode electrode and a cathode electrode separated by an electrically insulating separator film, and provided respectively with an anode current collector and a cathode current collector.

To manufacture such an electrochemical cell, and in particular an electrochemical cell with liquid electrolyte, it is known to use a sealed enclosure to contain a liquid electrolyte that ensures ionic conduction between the anode electrode and the cathode electrode as well as within each of these two electrodes. The major drawbacks lie in the production and sealing of the enclosure, as well as in the filling thereof with liquid electrolyte and in the subsequent risks of leakage likely to cause incidents such as inflammations, explosions and environmental pollution.

There is therefore a need for a manufacturing method that is reliable, industrializable and economical.

Document WO2022/013741 thus proposes a manufacturing method that implements the manufacturing of an anode half-cell by solidifying a pasty cathode layer comprising a first electrolyte mixture cross-linkable under radiation, then the manufacturing of an anode half-cell by solidifying a pasty anode layer comprising a second electrolyte mixture cross-linkable under radiation. The assembly of these two half-cells is carried out after having previously subjected each of them to at least one radiation for the initiation of their crosslinking, while interposing a separation layer and before completion of their crosslinking, subsequently ensuring the solidification of the cell.

Although the half-cells and the separation layer are assembled before complete solidification, this method does not provide optimized surface cohesion between the separation layer and each of the two half-cells, mainly because of the surface effects of the cross-linkable electrolyte mixtures that have started to solidify/crosslink in a non-homogeneous manner between them, so that the ionic conductivity of the cell is affected. The homogeneity of the crosslinking is accentuated by the characteristics of the layer to be crosslinked (thickness, density of the constituents, color, presence of bodies opaque to radiation) making this method poorly suited to very thick electrochemical cells and requiring several stages of thin-layer deposition followed by exposure to radiation to properly initiate crosslinking of the thin layer.

### SUMMARY OF THE INVENTION

An aim of the invention is to propose a method for manufacturing an electrochemical cell of a battery that is both economical and usable on an industrial scale, and that provides improved results in terms of ionic conductivity, electronic conduction and that is suitable for cells of great thickness.

To this end, the invention proposes a method for manufacturing an electrochemical cell of a battery with a polymer matrix, comprising the following steps:
a first covering step during which an anode current collector film is covered or impregnated with an anode mixture that is in a pasty or semi-liquid state and that contains at least one anode active material dispersed in a first cross-linkable liquid electrolyte containing a first cross-linkable composition, so as to form an anode electrode;
a second covering step in which a cathode current collector film is covered or impregnated with a cathode mixture which is in a pasty or semi-liquid state and which contains at least one cathode active material dispersed in a second cross-linkable liquid electrolyte containing a second cross-linkable composition, so as to form a cathode electrode;
a third impregnating step during which a porous electrically insulating separator film is impregnated with a third cross-linkable liquid or semi-liquid electrolyte containing a third cross-linkable composition, so as to form a pre-impregnated separator film;
a stacking step during which the anode electrode and the cathode electrode are stacked against each other, by interposing the pre-impregnated separator film, between the anode electrode and the cathode electrode, so as to form a stack;
a solidifying step, after the stacking step, during which the stack is exposed to at least one electron beam so that the first cross-linkable liquid electrolyte, the second cross-linkable liquid electrolyte and the third cross-linkable liquid or semi-liquid electrolyte solidify in bulk in both the anode electrode, the cathode electrode and the separator film, thereby forming the polymer matrix electrochemical cell.

Thus, the invention proposes to produce two polymer matrix half-cells, which are formed respectively from the anode electrode obtained at the end of the first covering step and the cathode electrode obtained at the end of the second covering step, then to assemble them with the interposition of the separator film (which electrically insulates the two half-cells), which will make it possible to obtain optimal surface cohesion between the separator film and each of the two half-cells. Indeed, since the anode mixture and the cathode mixture are still in a pasty or semi-liquid state and the crosslinking of the first and second cross-linkable liquid electrolytes has not yet begun (in other words the solidification of the anode mixture and the cathode mixture has not yet begun), these first and second cross-linkable liquid electrolytes will be able to insert themselves intimately into the pores/holes of the separator film, itself impregnated with the third cross-linkable liquid or semi-liquid electrolyte, during the stacking step and, where appropriate, into the pores/holes of the current collector films, before solidification (sometimes also called gelation) which will only be initiated after the stacking step, which will then form a continuous polymer matrix throughout the stack at the end of the solidification step.

In other words, the stacking step, before the solidification step, promotes the interpenetration of the first and second cross-linkable liquid electrolytes, both in the separator film and, where appropriate, in the current collector films, to obtain a polymer matrix throughout the stack after crosslinking, promoting on the one hand the ionic conductivity between the two electrodes and on the other hand the electronic conductivity between each electrode and its respective current collector, thus allowing subsequent charge and discharge cycles of the final cell.

It is quite clear that the dimensions of the pores/holes of the separator film are such that the active materials and the electron-conducting charges cannot be inserted inside these pores/holes of the separator film; this separator film must remain an electrically insulating layer, while allowing ionic conduction through it.

In addition, the third impregnation step is advantageous for increasing the interpenetration and surface cohesion between the separator film and each of the two half-cells, before solidification. In the case where the anode mixture and the cathode mixture contain electron-conducting charges (as described later), this also makes it possible to reinforce the electrical insulation at the separator film by preventing electron-conducting charges of the anode mixture (and therefore ultimately of the anode electrode) from coming into contact with electron-conducting charges of the cathode mixture (and therefore ultimately of the cathode electrode).

And finally, the solidification step, under exposure to at least one electron beam, will allow homogeneous solidification in mass by structuring the polymer matrix over the entire thickness of the stack, to form the polymer matrix electrochemical cell which will certainly be solid, but which will have properties equivalent to, or at least close to, those of liquid electrolyte cells. Indeed, this method will allow the production of a polymer matrix stack comprising within it interconnected liquid domains or islands, of nanometric or micrometric dimensions, strongly ion exchangers between the anode and cathode electrodes, and containing, where appropriate, electron-conducting charges enveloped within the polymer matrix to ensure electronic conduction in the electrodes towards their respective current collectors.

With this method, the cell obtained at the end (or final electrochemical cell) can be sectioned to the desired dimensions, thus making it possible to obtain a plurality of electrochemical cells which can be assembled in series, in parallel, in series/parallel, for example by simple superposition of the conductive outer faces of the current collector films, to constitute multi-cell batteries.

According to a variant, the anode mixture and the cathode mixture are pasty or semi-liquid mixtures each having for example a viscosity comprised between 10000 and 30000 cps (Centipoises).

According to a possibility, the first cross-linkable liquid electrolyte and the second cross-linkable liquid electrolyte do not contain any electron-conducting charge.

According to a characteristic, the first cross-linkable composition, the second cross-linkable composition and the third cross-linkable composition are analogous.

It is indeed advantageous to use similar (and for example identical) cross-linkable compositions for the two half-cells and the separator film, to promote ionic conduction in the interface zone with the separator film.

According to a possibility, the first cross-linkable composition, the second cross-linkable composition and the third cross-linkable composition respectively comprise a first monomer or prepolymer mixture, a second monomer or prepolymer mixture and a third monomer or prepolymer mixture, which each comprise monomers or prepolymers or a combination of monomers and prepolymers, where the monomers or prepolymers comprise crosslinking functions for solidifying the anode mixture, the cathode mixture and the third cross-linkable liquid or semi-liquid electrolyte upon exposure to the at least one electron beam.

Advantageously, the first cross-linkable composition and the second cross-linkable composition are each without crosslinking initiator additive.

The absence of such additives makes it possible to limit the presence of inactive materials and therefore to increase the mass energy density of the cell.

According to another possibility, the crosslinking functions are selected from acrylate, methacrylate, vinyl, styrene, isocyanate, acrylamide and methacrylamide functions.

Of course, the invention cannot be limited to such functions, but they have the advantage of being effective.

According to another possibility, the first cross-linkable composition has a mass percentage in the anode mixture, which is comprised between 2 and 20%, and for example between 3 and 7%, and the second cross-linkable composition has a mass percentage in the cathode mixture, which is comprised between 2 and 20%, and for example between 3 and 7%.

In a particular embodiment, the first covering step implements roll-to-roll deposition or impregnation of the anode mixture onto the anode current collector film such that the anode electrode forms a first continuous strip, the second covering step implements roll-to-roll deposition or impregnation of the cathode mixture onto the cathode current collector film such that the cathode electrode forms a second continuous strip, and the third impregnation step implements continuous impregnation of the separator film with the third cross-linkable liquid or semi-liquid electrolyte such that the pre-impregnated separator film forms a third continuous strip that is intercalated between the first continuous strip and the second continuous strip during the stacking step.

The roll-to-roll deposition or impregnation technique is particularly advantageous for industrial-scale implementation, because it is both economical and fast, which will also allow continuous stacking of the three strips.

It is moreover specified that the third cross-linkable liquid or semi-liquid electrolyte does not contain any electron-conducting charge.

According to a possibility, the third cross-linkable composition is without crosslinking initiator additive.

Advantageously, the third cross-linkable composition is identical to the first cross-linkable composition and to the second cross-linkable composition.

Thus, it is sufficient to prepare only one cross-linkable composition which will be used in the first, second and third cross-linkable liquid electrolytes.

Advantageously, in the third impregnation step, the third cross-linkable liquid or semi-liquid electrolyte is impregnated throughout the volume of the separator film, to promote cohesion with the anode electrode and the cathode electrode plated on two opposite faces of the separator film.

According to another possibility, the separator film is continuously unwound from a third coil and continuously impregnated with the third cross-linkable liquid or semi-liquid electrolyte to form the third continuous strip.

In a variant not covered by the claims, the separator film may not be pre-impregnated with such a third cross-linkable liquid or semi-liquid electrolyte, to be directly and as is intercalated between the two half-cells (in other words between the anode electrode and the cathode electrode); in this case the separator film may for example be in the form of a fine mesh fabric made of electrically insulating polymer.

In an advantageous embodiment, the stacking step implements a compression of the stack before exposing it to the at least one electron beam.

The compression of the stack promotes intimate surface contact between the layers, successively the anode electrode, the separator film and the cathode electrode, and also the control of its thickness.

This compression of the stack can for example be carried out by continuous rolling or by a press, such as a hydraulic or mechanical press.

Advantageously, the compression of the stack is carried out by continuous compression, between two rolling rollers of the first continuous strip, the third continuous strip and the second continuous strip.

Indeed, such compression by continuous rolling promotes productivity, while allowing precise control of the thickness of the stack before solidification.

According to a particular embodiment, the method comprises a final compression step during which the stack is compressed, for example by continuous rolling or by a press, after having been exposed to the at least one electron beam.

According to a characteristic, the anode active material includes particles of anode active material having maximum dimensions comprised between 0.5 and 200 micrometers, and for example between 1 and 20 micrometers, and the cathode active material includes particles of cathode active material having maximum dimensions comprised between 0.5 and 200 micrometers, and for example between 1 and 20 micrometers.

According to another characteristic, the particles of anode active material and the particles of cathode active material are particles of spherical or substantially spherical shape.

Such a spherical, or substantially spherical, shape is advantageous for having anode and cathode mixtures that are homogeneous and thus allow the active particles to be well distributed before mass crosslinking, which is favorable to ionic conduction.

In a particular embodiment, the anode mixture contains first electron-conducting charges dispersed in the first cross-linkable liquid electrolyte, and the cathode mixture contains second electron-conducting charges dispersed in the second cross-linkable liquid electrolyte.

According to a possibility, the first electron-conducting charges and the second electron-conducting charges are charges having at least one nanometric dimension comprised between 1 and 200 nanometers.

According to another possibility, the first electron-conducting charges and the second electron-conducting charges are:
carbonaceous charges selected from carbon black, carbon nanofibers, titanium nitride-coated carbon nanofibers, carbon nanotubes, graphene powders, and graphene oxide powders; or
non-carbonaceous charges selected from metal fibers, metal powders such as carbon fluoride powders, aluminum or nickel powders, conductive metal oxides, conductive polymers, and conductive ceramic powders.

According to a variant, the first electron-conducting charges and the second electron-conducting charges have mass percentages in the respective anode mixture and cathode mixture, which are comprised between 0.1 and 10%, and for example between 0.5 and 5%.

According to a variant, the first cross-linkable liquid electrolyte and the second cross-linkable liquid electrolyte each comprise at least one lithium or sodium salt dissolved in at least one liquid solvent.

Likewise, the third cross-linkable liquid electrolyte may comprise at least one lithium or sodium salt dissolved in at least one liquid solvent.

Advantageously, the first cross-linkable liquid electrolyte and the second cross-linkable liquid electrolyte each comprise at least one surfactant with a mass percentage comprised between 1 and 5%, and for example between 2 and 4%.

Such a surfactant promotes the wrapping of the electron-conducting charges by the crosslinked monomers or prepolymers, which is advantageous for improving safety and preventing the formation of dendrites.

Similarly, the third cross-linkable liquid electrolyte may comprise at least one surfactant with a mass percentage comprised between 1 and 5%, and for example between 2 and 4%.

According to a characteristic, the first covering step implements an unwinding of the anode current collector film, which is previously wound on a first coil; and covering or impregnating the anode current collector film with the anode mixture, as it is unwound.

According to another characteristic, the second covering step implements an unwinding of the cathode current collector film, which is previously wound on a second coil; and the covering or the impregnating of the cathode current collector film with the cathode mixture, as it is unwound.

In an advantageous embodiment, the first covering step comprises a first thickness calibration step which consists of a mechanical adjustment of a thickness, called the first thickness, of the anode electrode before the stacking step.

In this way, this first thickness is controlled, which promotes the control of the thickness of the final cell. Moreover, this calibration makes it possible to evacuate any excess anode mixture deposited (or excess first cross-linkable liquid electrolyte), which will be evacuated for example at least in part through the lateral parts of the anode electrode and/or where appropriate through the pores/holes of the anode current collector film.

Advantageously, the first thickness is adjusted to a value comprised between 10 and 1000 micrometers, and for example between 30 and 500 micrometers.

In a particular embodiment, the first thickness calibration step is implemented by compressing the anode electrode, before the stacking step.

According to a possibility, the anode electrode is compressed by continuous rolling between two rolling rollers comprising a first input roller and a first output roller.

According to another possibility, the anode current collector film is continuously conveyed into the first input roller, and the anode mixture is deposited to cover or impregnate said anode current collector film at this first input roller to form the anode electrode, this anode electrode being continuously conveyed between the first input roller and the first output roller to be compressed and then conveyed out of the first output roller.

In an advantageous embodiment, the second covering step comprises a second thickness calibration step which consists of a mechanical adjustment of a thickness, called the second thickness, of the cathode electrode.

In this way, this second thickness is controlled, which promotes control of the thickness of the final cell. Moreover, this calibration makes it possible to evacuate any excess of deposited cathode mixture (or excess of second cross-linkable liquid electrolyte), which will be evacuated for example at least in part through the lateral parts of the cathode electrode and/or where appropriate through the pores/holes of the cathode current collector film.

Advantageously, the second thickness is adjusted to a value comprised between 10 and 1000 micrometers, and for example between 30 and 500 micrometers.

In a particular embodiment, the second thickness calibration step is implemented by compressing the cathode electrode, before the stacking step.

According to a possibility, the cathode electrode is compressed by continuous rolling between two rolling rolls comprising a second input roll and a second output roll.

According to another possibility, the cathode current collector film is continuously conveyed into the second input roll, and the cathode mixture is deposited to cover or impregnate said cathode current collector film at said second input roll to form the cathode electrode, said cathode electrode being continuously conveyed between the second input roll and the second output roll to be compressed and then conveyed out of the second output roll.

According to a variant, during the solidification step, the stack is exposed to at least one electron beam which comprises:
a single electron beam facing one of the anode electrode or the cathode electrode, or
two electron beams facing respectively the anode electrode and the cathode electrode.

To achieve complete solidification of the stack of the formed electrochemical cell, the number of beams will depend on the thickness and mass density of each of the constituent strips of the stack, the irradiation dose emitted by each of the beams and the scrolling speed of the stack in front of the electron beam(s).

According to a characteristic, the at least one electron beam has an irradiation dose characteristic comprised between 10 and 100 kGy, and for example between 50 and 80 kGy.

According to another characteristic, the at least one electron beam has an acceleration voltage characteristic comprised between 100 keV and 1 MeV.

According to yet another characteristic, a scrolling speed of the stack has a speed characteristic comprised between 1 and 500 m/min, and for example between 1 and 30 m/min.

According to a variant, at least one of the anode current collector film and the cathode current collector film is selected from:
a metal laminated film, for example made of copper or aluminum, provided with perforations;
a polymer(s) and metal fibers based-metal composite porous film assembled to form a nonwoven fabric;
a polymer(s) and carbon fibers based-carbon composite porous film assembled to form a nonwoven fabric, the carbon fibers having optionally (therefore not necessarily) undergone pretreatment to improve their electronic and thermal conductivities;
a carbon fibers-based porous film assembled to form a nonwoven fabric, the carbon fibers having optionally (therefore not necessarily) undergone pretreatment to improve their electronic and thermal conductivities.

It should be noted that when the anode current collector film is a metal laminated film, the first covering step implements covering this metal laminated film with the anode mixture. Similarly, when the cathode current collector film is a metal laminated film, the second covering step implements covering this metal laminated film with the cathode mixture.

When the anode current collector film is a porous film, the first covering step implements the impregnation of this porous film with the anode mixture. Similarly, when the cathode current collector film is a porous film, the second covering step implements the impregnation of this porous film with the cathode mixture.

According to a possibility, the perforations of the metal laminated film have maximum dimensions comprised between 0.5 and 2 millimeters and are distributed with a density comprised between 2 and 10 perforations per cm2.

According to another possibility, the pretreatment comprises a deposition on the carbon fibers of a pretreatment layer based on titanium nitride or titanium carbide or titanium nitride and carbide, said pretreatment layer having a thickness comprised between 100 and 1000 nanometers.

In an embodiment, the anode current collector film comprises an inner anode face on which the anode mixture is deposited or impregnated during the first covering step, and an outer anode face, opposite the inner anode face, where said outer anode face is covered or impregnated beforehand with a layer of conductive varnish which is leak-tight and electrically conductive;
and the cathode current collector film comprises an inner cathode face on which the cathode mixture is deposited or impregnated during the second covering step, and an outer cathode face, opposite the inner cathode face, where said outer cathode face is covered or impregnated beforehand with another layer of conductive varnish which is leak-tight and electrically conductive.

These two layers of conductive varnish will at least partially ensure the sealing of the cell; the technical purpose of such sealing being to prevent moisture and air from entering the electrochemical cell, as well as the evaporation of solvents from the liquid electrolytes. These two layers of conductive varnish may, for example, harden upon exposure to at least one electron beam during the solidification step (of the electrochemical cell), or be hardened before the covering steps.

According to a characteristic, the layer of conductive varnish and the other layer of conductive varnish each have a thickness less than or equal to 30 micrometers, for example comprised between 5 and 30 micrometers.

Advantageously, the first covering step and the second covering step are carried out in parallel.

In an advantageous embodiment, the stack has two opposite longitudinal edges, and the manufacturing method comprises a step of applying electrically insulating varnish, after the stacking step and before the solidification step, during which two layers of electrically insulating varnish, leak-tight and electrically insulating, are deposited respectively on the two opposite longitudinal edges of the stack.

These two layers of electrically insulating varnish will contribute to the sealing of the cell.

Advantageously, the two layers of electrically insulating varnish harden upon exposure to the at least one electron beam during the solidification step.

Thus, this electrically insulating varnish comprises monomers or prepolymers or a combination of monomers and prepolymers, where the monomers or prepolymers comprise crosslinking functions for solidification upon exposure to the at least one electron beam.

Advantageously, the anode current collector film has two opposite longitudinal edges defining between them a width of the anode current collector film, and the anode mixture is deposited to cover or impregnate said anode current collector film, during the first covering step, to form a strip having a width less than the width of the anode current collector film, thus leaving the two longitudinal edges of the anode current collector film uncovered and unimpregnated with the anode mixture,
the cathode current collector film has two opposite longitudinal edges defining between them a width of the cathode current collector film, and the cathode mixture is deposited to cover or impregnate said cathode current collector film, during the second covering step, to form a strip having a width less than the width of the cathode current collector film, thus leaving the two longitudinal edges of the cathode current collector film uncovered and unimpregnated with the mixture cathode,
so that the two opposite longitudinal edges of the stack are free of the anode mixture and the cathode mixture before the step of applying the electrically insulating varnish.

According to a variant, the active anode material is selected from anode materials, used alone or in combination, based on:
carbon, such as graphite,
silicon,
carbonaceous silicon or lithiated silicon,
transition metals or alloys of transition metals,
composite materials combining transition metals and carbon,
lithium metal,
sodium metal,
lithium titanate,
aluminum, or magnesium, or tin, or zinc.

According to another variant, the cathode active material is selected from cathode materials, used alone or in combination, based on:
lithiated Nickel Manganese Cobalt,
lithiated Nickel Cobalt Aluminum,
lithiated Iron Phosphate,
lithiated Lithium Cobalt Oxide,
lithiated Manganese Oxide,
sulfur-carbon composite in the presence of a lithiated anode material,
lithium sulfide,
sodium alloy, such as for example with Na3V2(PO4)2F3.

In an embodiment, the first covering step, the second covering step, the stacking step and the solidification step are carried out in an anhydrous atmosphere, and for example in an argon or carbon dioxide atmosphere.

This atmosphere is advantageous for the safety of the method.

The invention also relates to an installation for manufacturing an electrochemical cell of a polymer matrix battery, comprising the following stations:
a first covering station comprising a first distributor of an anode current collector film, a first reservoir containing an anode mixture which is in a pasty or semi-liquid state and which contains at least one anode active material dispersed in a first cross-linkable liquid electrolyte containing a first cross-linkable composition, and a first covering unit for covering or impregnating the anode current collector film with the anode mixture so as to form an anode electrode;
a second covering station comprising a second distributor of a cathode current collector film, a second reservoir containing a cathode mixture which is in a pasty or semi-liquid state and which contains at least one cathode active material dispersed in a second cross-linkable liquid electrolyte containing a second cross-linkable composition, and a second covering unit for covering or impregnating the cathode current collector film with the cathode mixture so as to form a cathode electrode;
a third impregnation station comprising a third distributor of a separator film, electrically insulating and porous, and an impregnation unit for impregnating the separator film with a third cross-linkable liquid or semi-liquid electrolyte so as to form a pre-impregnated separator film;
a stacking station for stacking the anode electrode and the cathode electrode, with an interposition of the pre-impregnated separator film between the anode electrode and the cathode electrode, to form a stack;
a solidification station, at the outlet of the stacking station, comprising at least one electron beam generator for exposing said stack to at least one electron beam so that the first cross-linkable liquid electrolyte, the second cross-linkable liquid electrolyte and the third cross-linkable liquid or semi-liquid electrolyte solidify in mass both in the anode electrode, the cathode electrode and the separator film, thus forming the polymer matrix electrochemical cell.

This installation may also have all or part of the characteristics associated with the method described above.

### BRIEF DESCRIPTION OF THE FIGURES

Other characteristics and advantages of the present invention will appear on reading the detailed description below, of a non-limiting exemplary implementation, made with reference to the appended figures in which:

FIG. 1 is a schematic view of a manufacturing installation according to an exemplary embodiment of the invention, suitable for implementing a manufacturing method, according to the invention, of an electrochemical cell of a polymer matrix battery;

FIG. 2 is a schematic view of the first covering unit of the installation of FIG. 1, for covering or impregnating an anode current collector film with an anode mixture and forming an anode electrode;

FIG. 3 is a schematic view of the second covering unit of the installation of FIG. 1, for covering or impregnating a cathode current collector film with a cathode mixture and forming a cathode electrode;

FIG. 4 is a schematic view of the impregnation unit of the third impregnation station, and of the stacking station of the installation of FIG. 1, for stacking the anode electrode and the cathode electrode, with an interposition of the pre-impregnated separator film;

FIG. 5 is a schematic top view of an anode current collector film partially covered with the anode mixture in the first covering unit;

FIG. 6 is a schematic top view of a cathode current collector film partially covered with the cathode mixture in the second covering unit;

FIG. 7 is a schematic cross-sectional view of an electrochemical cell of a polymer matrix battery obtained at the outlet of the installation;

FIG. 8 is a schematic cross-sectional view of a variant of an electrochemical cell of a polymer matrix battery;

FIG. 9 is a schematic view of a coil winder, which follows the installation of FIG. 1 to form a cell coil.

### DETAILED DESCRIPTION OF ONE OR MORE EMBODIMENTS OF THE INVENTION

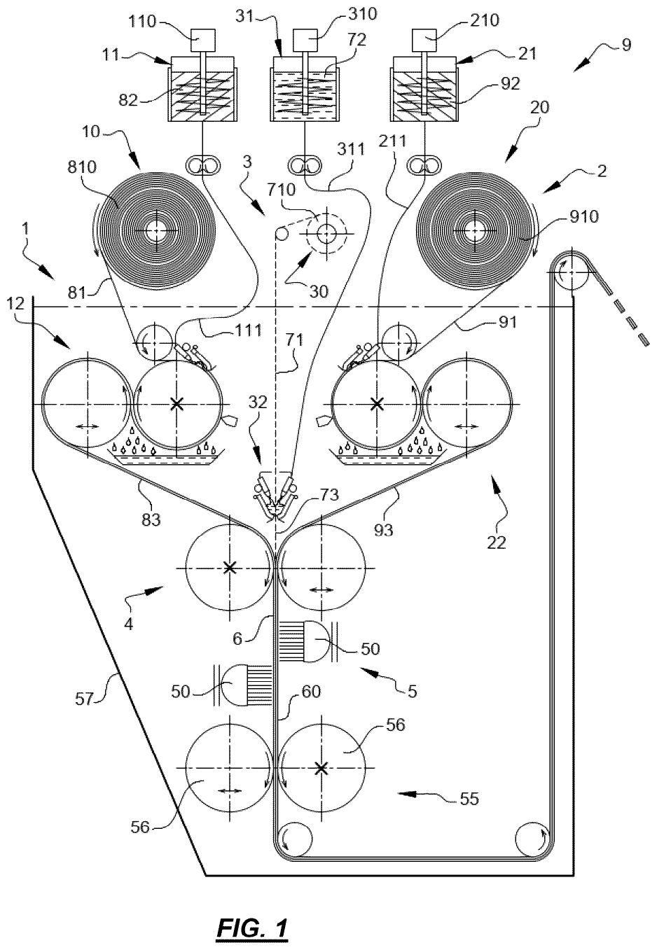

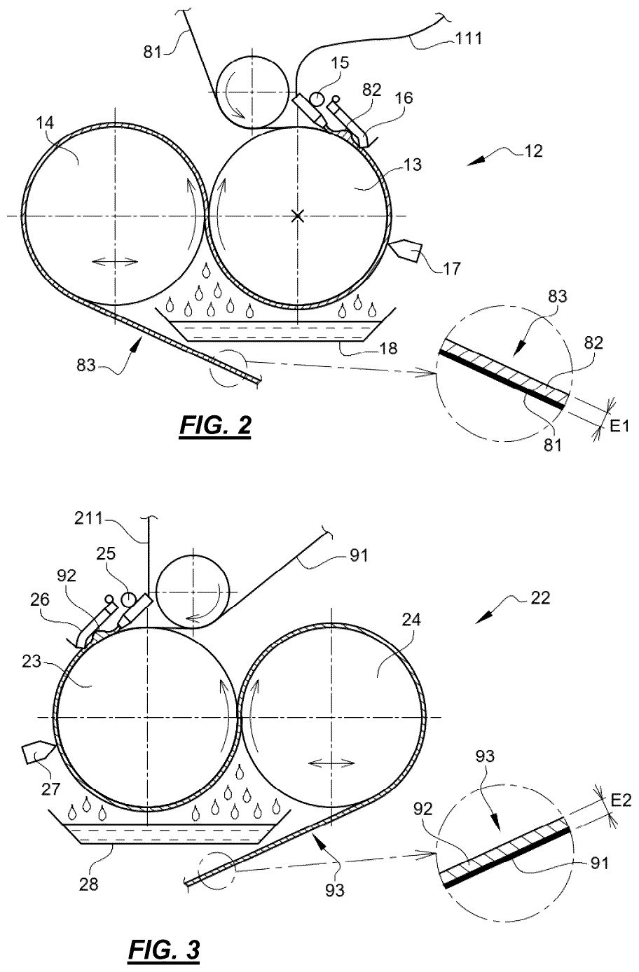

FIG. 1 illustrates an installation 9 for manufacturing an electrochemical cell of a polymer matrix battery 60, and its various stations described below.

The installation 9 comprises a first covering station 1 which comprises a first distributor 10 for distributing an anode current collector film 81. This first distributor 10 is in the form of a coil unwinder or dispenser, and the anode current collector film 81 is in the form of a first coil 810 which is unwound from the first distributor 10 in a continuous manner.

This anode current collector film 81 is selected from:
a metal laminated film, for example made of copper or aluminum, provided with perforations, the maximum dimensions of which are for example comprised between 0.5 and 2 millimeters and which are distributed with a density of for example between 2 and 10 perforations per cm2;
a polymer(s) and metal fibers based-metal composite porous film assembled to form a nonwoven fabric;
a polymer(s) and carbon fibers based-carbon composite porous film assembled to form a nonwoven fabric, the carbon fibers having optionally undergone pretreatment to improve their electronic and thermal conductivities;
a carbon fibers based-porous film assembled to form a nonwoven fabric, the carbon fibers having optionally undergone pretreatment to improve their electronic and thermal conductivities.

This pretreatment of the carbon fibers consists, for example, of depositing on the carbon fibers a pretreatment layer based on titanium nitride or titanium carbide or titanium nitride and carbide, this pretreatment layer having, for example, a thickness comprised between 100 and 1000 nanometers.

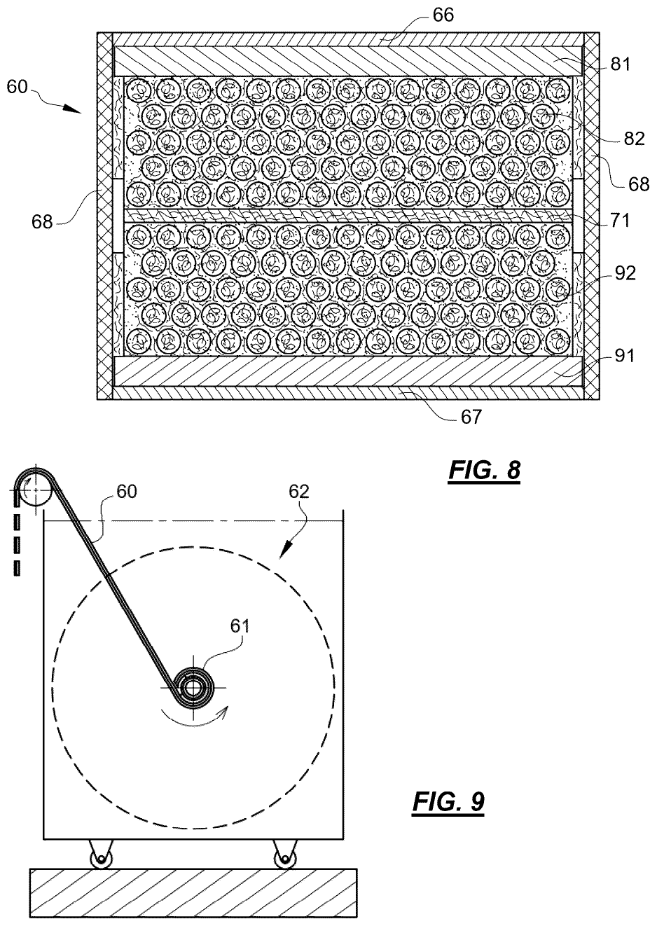

The anode current collector film 81 has an inner face and an opposite outer face. According to a possibility, the outer face of the anode current collector film 81 is covered or impregnated beforehand with a layer of conductive varnish 66 (see FIG. 8) which is leak-tight and electrically conductive. This layer of conductive varnish 66 has, for example, a thickness of less than or equal to 30 micrometers, for example comprised between 5 and 30 micrometers.

The first covering station 1 also comprises a first reservoir 11 containing an anode mixture 82 which is in a pasty or semi-liquid state (with for example a viscosity comprised between 10,000 and 30,000 cps) and which contains at least one active anode material and first electron-conducting charges dispersed in a first cross-linkable liquid electrolyte containing a first cross-linkable composition.

This first reservoir 11 is a sealed reservoir and in an anhydrous atmosphere, and for example in an atmosphere of an inert gas such as for example argon or carbon dioxide. This first reservoir 11 is advantageously equipped with a mechanical mixer or stirrer 110 to homogenize the anode mixture 82.

According to a possibility, the first cross-linkable composition has a mass percentage in the anode mixture 82, which is comprised between 2 and 20%, and for example between 3 and 7%. This first cross-linkable composition comprises a first monomer or prepolymer mixture, which comprises monomers or prepolymers or a combination of monomers and prepolymers, where the monomers or prepolymers comprise crosslinking functions for crosslinking the first cross-linkable liquid electrolyte (and therefore solidifying the anode mixture 82) upon exposure to an electron beam. These crosslinking functions are for example selected from acrylate, methacrylate, vinyl, styrene, isocyanate, acrylamide and methacrylamide functions.

According to a possibility, the first electron-conducting charges have a mass percentage in the anode mixture 82, which is comprised between 0.1 and 10%, and for example between 0.5 and 5%. These first electron-conducting charges are advantageously charges having at least one nanometric dimension comprised between 1 and 200 nanometers, and are:
either carbon charges selected from carbon black, carbon nanofibers, carbon nanofibers coated with titanium nitride, carbon nanotubes, graphene powders, and graphene oxide powders;
or non-carbon charges selected from metal fibers, metal powders such as carbon fluoride powders, aluminum or nickel powders, conductive metal oxides, conductive polymers, and conductive ceramic powders.

According to another possibility, the first cross-linkable liquid electrolyte comprises at least one lithium or sodium salt dissolved in at least one liquid solvent. It is conceivable that the first cross-linkable liquid electrolyte comprises a surfactant with a mass percentage comprised between 1 and 5%, and for example between 2 and 4%.

According to another possibility, the anode active material includes particles of anode active material having maximum dimensions comprised between 0.5 and 200 micrometers, and for example between 1 and 20 micrometers. These particles of anode active material are advantageously particles of spherical or substantially spherical shape. This anode active material is selected from anode materials, used alone or in combination, based on:
carbon, such as for example graphite,
silicon,
carbonaceous silicon or lithiated silicon,
transition metals or alloys of transition metals,
composite materials combining transition metals and carbon,
lithium metal,
sodium metal,
lithium titanate,
aluminum, or magnesium, or tin, or zinc.

The first covering station 1 further comprises a first covering unit 12 for covering or impregnating the anode current collector film 81, and more specifically its inner face, with the anode mixture 82 so as to form an anode electrode 83 comprising the anode current collector film 81 at least partially impregnated with the first cross-linkable liquid electrolyte and a layer of the anode mixture 82.

The first covering station 1 thus implements:
an unwinding of the anode current collector film 81, which is previously wound on the first coil 810 on the first distributor 10; and
the covering or impregnating, at the first covering unit 12, of the anode current collector film 81 with the anode mixture 82, as it unwinds; feeding the anode mixture 82 from the first reservoir 11 via a conduit 111.

This first covering unit 12 implements roll-to-roll deposition or impregnation of the anode mixture 82 on the anode current collector film 81 so that the anode electrode 83 forms a first continuous strip, and also implements compression of the anode electrode 83 by continuous rolling between two rolling rollers 13, 14 comprising a first input roller 13 and a first output roller 14. Also, the first covering unit 12 comprises these two rolling rollers 13, 14.

Thus, the anode current collector film 81 is continuously conveyed into the input on the first input roller 13, and the anode mixture 82 is deposited or impregnated on the inner face of the anode current collector film 81 at the level of this first input roller to form the anode electrode 83. The first covering unit 12 thus comprises a deposition nozzle 15 which is in fluid connection with the first reservoir 11 by means of the conduit 111, and which is arranged adjacent to the first input roller 13 to deposit or impregnate anode mixture 82 on the inner face of the anode current collector film 81.

With reference to FIG. 5, the anode current collector film 81 has two opposite longitudinal edges 811 defining between them a width L81 of the anode current collector film 81 (the arrow in this FIG. 5 illustrating the direction of advance or conveyance in the installation 9) and, according to an optional possibility, the anode mixture 82 is deposited or impregnated on the anode current collector film 81, in the first covering unit 12, to form a strip having a width L82 less than the width L81 of the anode current collector film 81, thus leaving the two longitudinal edges 811 of the anode current collector film 81 uncovered and unimpregnated with the anode mixture 82. In other words, the anode current collector film 81 has two edge strips 812, along these two respective longitudinal edges 811, which are uncovered and unimpregnated with the anode mixture 82.

The width L82 of this strip is preferably greater than or equal to 90% of the width L81 of the anode current collector film 81, thus leaving approximately 5% uncovered on each of the two edge strips 812 of the anode current collector film 81. Alternatively, the anode mixture 82 is deposited or impregnated over the entire width L81 of the anode current collector film 81.

The first covering unit 12 also comprises a scraper 16 which is arranged adjacent to the first input roller 13 and after the deposition nozzle 15, for scraping off excess anode mixture 82 deposited on the anode current collector film 81.

Following deposition by the deposition nozzle 15 and scraping by the scraper 16, the anode electrode 83 is continuously conveyed between the first input roller 13 (which is a fixed roller) and the first output roller 14 (which is a movable roller with compression spring) to be compressed and then conveyed out of the first output roller 14. Thus, the anode electrode 83 is compressed by continuous rolling between these two rolling rollers 13, 14.

This compression by rolling thus allows a thickness calibration which consists of a mechanical adjustment of a thickness, called first thickness E1, of the anode electrode 83. This first thickness E1 is advantageously adjusted to a value comprised between 10 and 1000 micrometers, and for example between 30 and 500 micrometers. The first covering unit 12 may comprise a first thickness sensor 17 placed on the path of the anode electrode 83 to measure this first thickness E1, and thus serve to control the compression operation.

This rolling compression also promotes the impregnation of the first cross-linkable liquid electrolyte in the thickness of the anode current collector film 81. This rolling compression also makes it possible to extract any surplus of first cross-linkable liquid electrolyte, which will be evacuated through porosities in the anode active material and/or holes in the anode current collector film 81; this surplus of first cross-linkable liquid electrolyte can be recovered in a recovery reservoir 18.

The installation 9 comprises a second covering station 2 which comprises a second distributor 20 for distributing a cathode current collector film 91. This second distributor 20 is in the form of a coil unwinder or dispenser, and the cathode current collector film 91 is in the form of a second coil 910 which is unwound from the second distributor 20 continuously.

This cathode current collector film 91 is selected from:
a metal laminated film, for example made of copper or aluminum, provided with perforations, the maximum dimensions of which are for example comprised between 0.5 and 2 millimeters and which are distributed with a density comprised for example between 2 and 10 perforations per cm2;
a polymer(s) and metal fibers based-metal composite porous film assembled to form a nonwoven fabric;
a polymer(s) and carbon fibers based-carbon composite porous film assembled to form a nonwoven fabric, the carbon fibers having optionally undergone pretreatment to improve their electronic and thermal conductivities;
a carbon fibers based-porous film assembled to form a nonwoven fabric, the carbon fibers having optionally undergone pretreatment to improve their electronic and thermal conductivities.

This pretreatment of the carbon fibers consists, for example, of depositing on the carbon fibers a pretreatment layer based on titanium nitride or titanium carbide or titanium nitride and carbide, this pretreatment layer having, for example, a thickness comprised between 100 and 1000 nanometers.

The cathode current collector film 91 has an inner face and an opposite outer face. According to a possibility, the outer face of the cathode current collector film 91 is covered or impregnated beforehand with another layer of conductive varnish 67 (see FIG. 8) which is leak-tight and electrically conductive. This other layer of conductive varnish 67 has, for example, a thickness of less than or equal to 30 micrometers, for example comprised between 5 and 30 micrometers.

The second covering station 2 also comprises a second reservoir 21 containing a cathode mixture 92 which is in a pasty or semi-liquid state (with for example a viscosity comprised between 10,000 and 30,000 cps) and which contains at least one active cathode material and second electron-conducting charges dispersed in a second cross-linkable liquid electrolyte containing a second cross-linkable composition.

This second reservoir 21 is a sealed reservoir and in an anhydrous atmosphere, and for example in an atmosphere of an inert gas such as for example argon or carbon dioxide. This second reservoir 21 is advantageously equipped with a mechanical mixer or stirrer 210 to homogenize the cathode mixture 92.

According to a possibility, the second cross-linkable composition has a mass percentage in the cathode mixture 92, which is comprised between 2 and 20%, and for example between 3 and 7%. This first cross-linkable composition comprises a second monomer or prepolymer mixture, which comprises monomers or prepolymers or a combination of monomers and prepolymers, where the monomers or prepolymers comprise crosslinking functions for solidification of the second cross-linkable liquid electrolyte upon exposure to an electron beam. These crosslinking functions are for example selected from acrylate, methacrylate, vinyl, styrene, isocyanate, acrylamide and methacrylamide functions.

Advantageously, the first cross-linkable composition and the second cross-linkable composition are analogous, and for example they are identical.

According to a possibility, the second electron-conducting charges have a mass percentage in the cathode mixture 92, which is comprised between 0.1 and 10%, and for example between 0.5 and 5%. These first electron-conducting charges are advantageously charges having at least one nanometric dimension comprised between 1 and 200 nanometers, and are:
either carbon charges selected from carbon black, carbon nanofibers, carbon nanofibers coated with titanium nitride, carbon nanotubes, graphene powders, and graphene oxide powders;
or non-carbon charges selected from metal fibers, metal powders such as carbon fluoride powders, aluminum or nickel powders, conductive metal oxides, conductive polymers, and conductive ceramic powders.

According to another possibility, the second cross-linkable liquid electrolyte comprises at least one lithium or sodium salt dissolved in at least one liquid solvent. It is conceivable that the second cross-linkable liquid electrolyte comprises a surfactant with a mass percentage comprised between 1 and 5%, and for example between 2 and 4%.

According to another possibility, the cathode active material comprises particles of cathode active material having maximum dimensions comprised between 0.5 and 200 micrometers, and for example between 1 and 20 micrometers. These particles of cathode active material are advantageously particles of spherical or substantially spherical shape. This cathode active material is selected from cathode materials, used alone or in combination, based on:
lithiated Nickel Manganese Cobalt,
lithiated Nickel Cobalt Aluminum,
lithiated Iron Phosphate,
lithiated Lithium Cobalt Oxide,
lithiated Manganese Oxide,
sulfur-carbon composite in the presence of a lithiated anode material,
lithium sulfide,
sodium alloy, such as for example with Na3V2(PO4)2F3.

The second covering station 2 further comprises a second covering unit 22 for covering or impregnating the cathode current collector film 91, and more specifically its inner face, with the cathode mixture 92 so as to form a cathode electrode 93 comprising the cathode current collector film 91 at least partially impregnated with the second cross-linkable liquid electrolyte and a layer of the cathode mixture 92.

The second covering station 2 thus implements:
an unwinding of the cathode current collector film 91, which is previously wound on the second coil 910 on the second distributor 20; and
the covering or the impregnating, at the second covering unit 22, the cathode current collector film 91 with the cathode mixture 92, as it unwinds; the feeding of the cathode mixture 92 from the second reservoir 21 via a conduit 211.

This second covering unit 22 implements roll-to-roll a deposition or an impregnation of the cathode mixture 92 on the cathode current collector film 91 so that the cathode electrode 93 forms a second continuous strip, and also implements a compression of the cathode electrode 93 by continuous rolling between two rolling rollers 23, 24 comprising a second input roller 23 and a second output roller 24. Also, the second covering unit 22 comprises these two rolling rollers 23, 24.

Thus, the cathode current collector film 91 is continuously conveyed into the input on the second input roller 23, and the cathode mixture 92 is deposited or impregnated on the inner face of the cathode current collector film 91 at the level of this second input roller 23 to form the cathode electrode 93. The second covering unit 22 thus comprises a deposition nozzle 25 which is in fluid connection with the second reservoir 21 by means of the conduit 211, and which is arranged adjacent to the second input roller 23 to deposit or impregnate cathode mixture 92 on the inner face of the cathode current collector film 91.

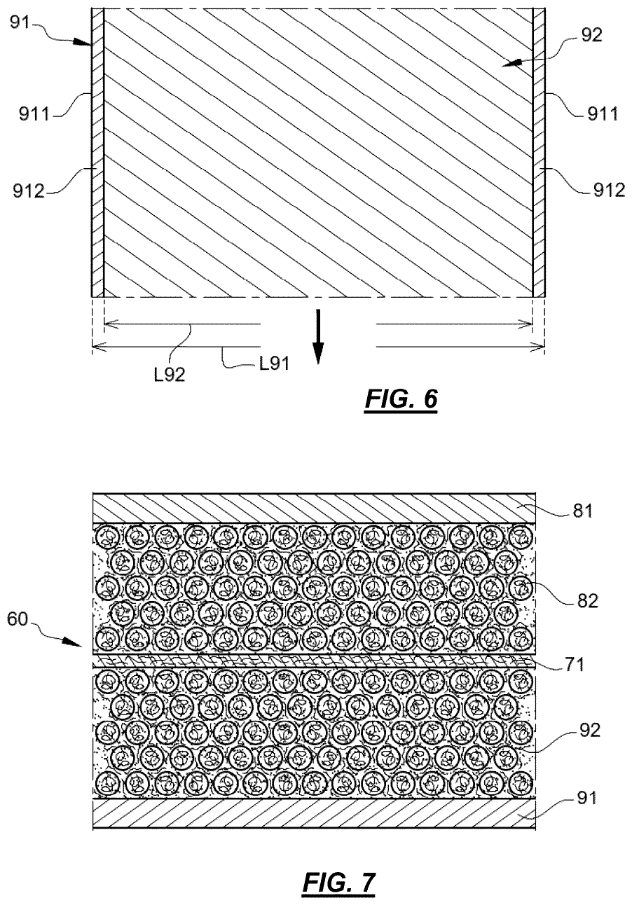

With reference to FIG. 6, the cathode current collector film 91 has two opposite longitudinal edges 911 defining between them a width L91 of the cathode current collector film 91 (the arrow in this FIG. 6 illustrating the direction of advance or conveyance in the installation 9) and, according to an optional possibility, the cathode mixture 92 is deposited or impregnated on the cathode current collector film 91, in the second covering unit 22, to form a strip having a width L92 less than the width L91 of the cathode current collector film 91, thus leaving the two longitudinal edges 911 of the cathode current collector film 91 uncovered and unimpregnated with the cathode mixture 92. In other words, the cathode current collector film 91 has two edge strips 912, along these two respective longitudinal edges 911, which are uncovered and unimpregnated with the cathode mixture 91.

The width L92 of this strip is preferably greater than or equal to 90% of the width L91 of the cathode current collector film 91, thus leaving approximately 5% uncovered on each of the two edge strips 912 of the cathode current collector film 91. Alternatively, the cathode mixture 92 is deposited or impregnated over the entire width L91 of the cathode current collector film 91.

The second covering unit 22 also comprises a scraper 26 which is disposed adjacent to the second input roller 23 and after the deposition nozzle 25, for scraping an excess of the cathode mixture 92 deposited on the cathode current collector film 91.

Following the deposition by the deposition nozzle 26 and scraping by the scraper 26, the cathode electrode 93 is continuously conveyed between the second input roller 23 (which is a fixed roller) and the second output roller 24 (which is a movable roller with a compression spring) to be compressed and then conveyed out of the second output roller 24. Thus, the cathode electrode 93 is compressed by continuous rolling between these two rolling rollers 23, 24.

This compression by rolling thus allows a thickness calibration which consists of a mechanical adjustment of a thickness, called the second thickness E2, of the cathode electrode 93. This second thickness E2 is advantageously adjusted to a value comprised between 10 and 1000 micrometers, and for example between 30 and 500 micrometers. The second covering unit 22 may comprise a second thickness sensor 27 placed on the path of the cathode electrode 93 to measure this second thickness E2, and thus serve to control the compression operation.

This compression by rolling also promotes the impregnation of the second cross-linkable liquid electrolyte in the thickness of the cathode current collector film 91. This compression by rolling also makes it possible to extract any surplus of second cross-linkable liquid electrolyte, which will be evacuated through porosities in the cathode active material and/or holes in the cathode current collector film 91; this surplus of second cross-linkable liquid electrolyte can be recovered in a recovery tank 28.

The installation 9 comprises a third impregnation station 3 which comprises a third distributor 30 for the distribution of a separator film 71 which is porous and electrically insulating. This third distributor 30 is in the form of a coil unwinder or dispenser, and the separator film 71 is in the form of a third coil 710 which is unwound from the third distributor 30 continuously. The separator film 71 has an inner face and an outer face which are opposite to each other.

This third impregnation station 3 comprises an impregnation unit 32 for impregnating the separator film 71 with a third cross-linkable liquid or semi-liquid electrolyte 72; this third cross-linkable liquid or semi-liquid electrolyte 72 containing a third cross-linkable composition for solidification of said third cross-linkable liquid or semi-liquid electrolyte under exposure to an electron beam.

This third impregnation station 3 also comprises a third reservoir 31 containing the third cross-linkable liquid or semi-liquid electrolyte 72 containing the third cross-linkable composition. This third reservoir 31 is a sealed reservoir and in an anhydrous atmosphere, and for example in an atmosphere of an inert gas such as for example argon or carbon dioxide. This third reservoir 31 is advantageously equipped with a mechanical mixer or stirrer 310 to homogenize the third cross-linkable liquid or semi-liquid electrolyte 72.

According to a possibility, the third cross-linkable composition comprises a third monomer or prepolymer mixture, which comprises monomers or prepolymers or a combination of monomers and prepolymers, where the monomers or prepolymers comprise crosslinking functions for a solidification of the third cross-linkable liquid or semi-liquid electrolyte during exposure to an electron beam. These crosslinking functions are for example selected from acrylate, methacrylate, vinyl, styrene, isocyanate, acrylamide and methacrylamide functions.

Advantageously, the third cross-linkable composition is similar, and for example identical, to the first cross-linkable composition and to the second cross-linkable composition.

According to another possibility, the third cross-linkable liquid or semi-liquid electrolyte comprises at least one lithium or sodium salt dissolved in at least one liquid solvent. It is conceivable that the third cross-linkable liquid or semi-liquid electrolyte comprises a surfactant with a mass percentage comprised between 1 and 5%, and for example between 2 and 4%.

Advantageously, the third cross-linkable liquid or semi-liquid electrolyte is similar, and for example identical, to the first cross-linkable liquid electrolyte and/or to the second cross-linkable liquid electrolyte.

The impregnation unit 32 is configured to impregnate the third cross-linkable liquid or semi-liquid electrolyte 72 on the two opposite faces (inner face and outer face) of the separator film 71, in order to impregnate the separator film 71 with the third cross-linkable liquid or semi-liquid electrolyte 72 over the entire volume of this separator film 71. Thus, the separator film 71 is continuously conveyed to the inlet of the impregnation unit 32, and the third cross-linkable liquid or semi-liquid electrolyte 72 is impregnated on the two opposite faces of the separator film 71, in the entire volume of the separator film 71, to form a pre-impregnated separator film 73 which is in the form of a third continuous strip. In other words, the separator film 71 is continuously unwound from the third coil 710 and is continuously impregnated with the third cross-linkable liquid or semi-liquid electrolyte 72 to form the pre-impregnated separator film 73 in the form of the third continuous strip 73.

The impregnation unit 32 comprises two deposition nozzles 35 which are in fluidic connection with the third reservoir 31 by means of a conduit 311, and which are arranged facing respectively the inner face and the outer face of the separator film 71 to deposit the third cross-linkable liquid or semi-liquid electrolyte 72 on the inner face and the outer face of the separator film 71. The impregnation unit 32 also comprises two scrapers 36 which are arranged after the two respective deposition nozzles 35, to scrape excesses of the third cross-linkable liquid or semi-liquid electrolyte 72 impregnated on the two opposite faces of the film separator 71.

The first covering station 1, the second covering station 2 and the third impregnation station 3 operate continuously and in parallel.

The installation 9 comprises a stacking station 4 for stacking the anode electrode 83 (which forms the first continuous strip at the outlet of the first covering station 1) and the cathode electrode 93 (which forms the second continuous strip at the outlet of the second covering station 2), with an interposition of the pre-impregnated separator film 73 (which forms the third continuous strip 73 at the outlet of the third impregnation station 3) between the anode electrode 83 and the cathode electrode 93. Thus, on this stacking station 4, the third continuous strip (or pre-impregnated separator film 73) is intercalated or interposed between the first continuous strip (or anode electrode 83) and the second continuous strip (or cathode electrode 93).

Thus, this stacking station 4 makes it possible to obtain at the outlet and continuously a stack 6 successively comprising the anode current collector film 81 (partially impregnated with the first cross-linkable liquid electrolyte), the anode mixture 82, the separator film 71 impregnated with the third cross-linkable liquid or semi-liquid electrolyte 72, the cathode mixture 92 and the cathode current collector film 91 (partially impregnated with the second cross-linkable liquid electrolyte).

This stacking station 4 implements a compression of the stack 6, for example by continuous rolling or by a press, before exposing it to the at least one electron beam. This compression allows the first cross-linkable liquid electrolyte and the second cross-linkable liquid electrolyte to penetrate into the separator film 71, and therefore to associate them with the third cross-linkable liquid or semi-liquid electrolyte of the third continuous strip (or pre-impregnated separator film 73).

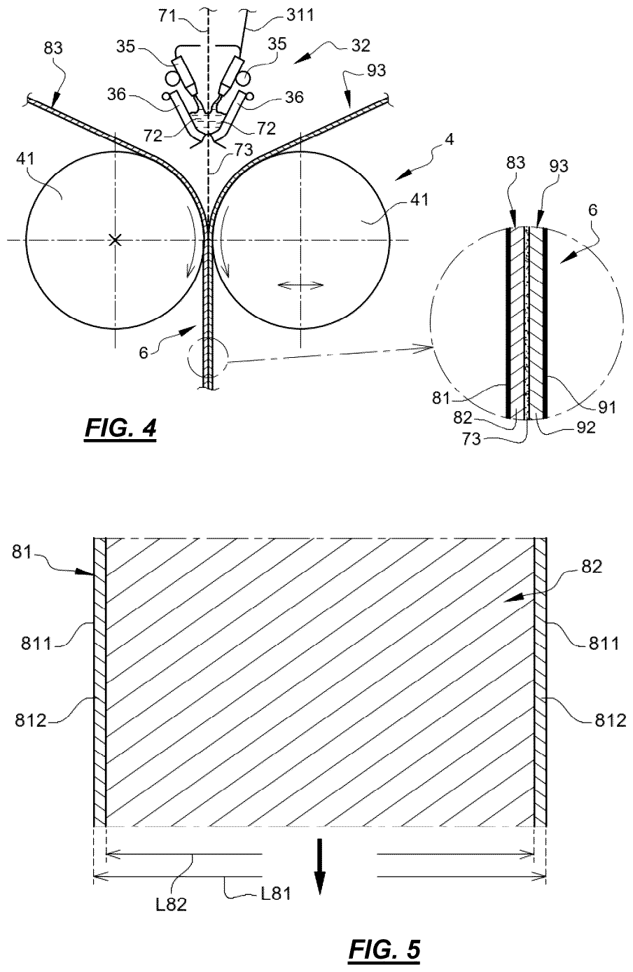

In the example illustrated in FIG. 4, the stacking station 4 comprises a continuous rolling mill having two rolling rollers 41 (with for example a fixed roller and a movable roller with compression spring) to carry out a continuous compression of the stack 6.

The installation 9 comprises, at the outlet of the stacking station 4, a solidification station 5 comprising at least one electron beam generator 50 to expose the stack 6 to at least one electron beam so that the first cross-linkable liquid electrolyte, the second cross-linkable liquid electrolyte and the third cross-linkable liquid or semi-liquid electrolyte crosslink or solidify in bulk at the same time in the anode current collector film 81, the anode mixture 82, the cathode mixture 92, the cathode current collector film 91 and the separator film 71, thus forming the polymer matrix electrochemical cell 60.

Under the effect of the electron beam(s), the crosslinking functions of the first cross-linkable composition, the second cross-linkable composition and the third cross-linkable composition will produce a mass solidification of the first cross-linkable liquid electrolyte, the second cross-linkable liquid electrolyte and the third cross-linkable liquid or semi-liquid electrolyte, thus forming a polymer matrix for the electrochemical cell 60 resulting from the installation 9 and therefore from the method implemented in this installation 9.

In the example illustrated in FIG. 1, the solidification station 5 comprises two electron beam generators 50 facing respectively the anode electrode 83 and the cathode electrode 93, in other words on either side of the stack 6 at the outlet of the stacking station 4.

As a variant, and depending on whether the targeted thickness and the mass densities of the constituent strips of the polymer matrix electrochemical cell 60 allow it, the solidification station 5 may comprise a single electron beam generator 50 facing one of the anode electrode 83 or the cathode electrode 93.

The or each electron beam generator 50 has:
an irradiation dose characteristic comprised between 10 and 100 kGy, and for example between 50 and 80 kGy;
an acceleration voltage characteristic comprised between 100 keV and 1 MeV.

According to a possibility, the scrolling speed of the stack 6, at the solidification station 5, has a speed characteristic comprised between 1 and 500 m/min, and for example between 1 and 30 m/min; this scrolling speed being ensured by ensuring a synchronization of the speeds in the previous stations, and in particular in the first covering station 1, the second covering station 2 and the third impregnation station 3 which operate continuously.

Optionally, the installation 9 comprises, between the stacking station 4 and the solidification station 5, a station for applying electrically insulating varnish to deposit two layers of electrically insulating varnish 68 (see FIG. 8), leak-tight and electrically insulating, on the two opposite longitudinal edges of the stack 6; where this electrically insulating varnish comprises monomers or prepolymers which comprise crosslinking functions for the solidification of the electrically insulating varnish upon exposure to at least one electron beam. Thus, the two layers of electrically insulating varnish 68 harden in the solidification station 5, during the exposure to the electron beam(s) 50.

The use of these layers of electrically insulating varnish 68 is suitable in the case described above (and illustrated in FIG. 5 and FIG. 6), where the two longitudinal edges 810 of the anode current collector film 81 are not covered and not impregnated with the anode mixture 82 and where the two longitudinal edges 910 of the cathode current collector film 91 are not covered and not impregnated with the cathode mixture 92, such that in this case the two opposite longitudinal edges of the stack 6 are free of the anode mixture 82 and the cathode mixture 92 before the application of electrically insulating varnish.

The installation 9 comprises, at the outlet of the solidification station 5, a final compression station 55 for compressing the stack 6, for example by continuous rolling or by a press, after having been exposed to the electron beam(s), in other words to compress the polymer matrix electrochemical cell 60.

In the illustrated example, the final compression station 55 comprises a continuous rolling mill having two rolling rollers 56 (with for example a fixed roller and a movable roller with compression spring) to carry out continuous compression of the polymer matrix electrochemical cell 60.

This polymer matrix electrochemical cell 60 is then in the form of a continuous strip which can be wound in the form of a cell coil 61 on a coil winder 62, as illustrated in FIG. 9.

Advantageously, the first covering unit 12, the second covering unit 22, the impregnation unit 32, the stacking station 4, the solidification station 5 and the final compression station 55 are arranged in an enclosure 57 in an anhydrous atmosphere, and for example in an argon or carbon dioxide atmosphere. The first distributor 10, the second distributor 20 and the third distributor 30 may be outside the enclosure 57.

FIG. 7 schematically illustrates a cross-section of the polymer matrix electrochemical cell 60 obtained at the outlet of the installation 9, with a superposition:
of the anode current collector film 81 inside which the first electrolyte has solidified, in particular at the interface with the anode mixture 82;
of the anode mixture 82 inside which the first electrolyte has solidified, taking in the mass the first electron-conducting charges (of nanometric dimensions) and the particles of anode active material (of micrometric dimensions);
of the separator film 71 inside which the third electrolyte has solidified, as well as the first electrolyte at the interface with the anode mixture 82 and the second electrolyte at the interface with the cathode mixture 92;
the cathode mixture 92 inside which the second electrolyte has solidified, taking in the mass the second electron-conducting charges (of nanometric dimensions) and the cathode active material particles (of micrometric dimensions);
the cathode current collector film 91 inside which the second electrolyte has solidified, in particular at the interface with the cathode mixture 92.

In the anode mixture 82 of the electrochemical cell 60 the anode active material particles are coated with the first solidified electrolyte, and in the cathode mixture 92 of the electrochemical cell 60 the cathode active material particles are coated with the second solidified electrolyte.

The term «solidified electrolyte» is used here in a simplified manner to express the fact that it is the crosslinking of the cross-linkable composition initially included in the corresponding liquid electrolyte, the electrolyte remaining trapped in the liquid state and forming domains or islands within the polymer matrix with the possibility of ionic exchanges between the different domains or islands, and coats the active materials and the electron-conducting charges.

FIG. 8 illustrates a variant of the electrochemical cell 60, which still comprises the same superposition, but which is sealed with in addition:
the conductive varnish layer 66, leak-tight and electrically conductive, on the outer face of the anode current collector film 81;
the other conductive varnish layer 67, leak-tight and electrically conductive, on the outer face of the cathode current collector film 82; and
the two layers of electrically insulating varnish 68, leak-tight and electrically insulating, on the two opposite longitudinal edges of the electrochemical cell 60 (these two layers of electrically insulating varnish 68 initially deposited on the stack 6 having hardened, during exposure to the electron beam(s) 50).

1. A manufacturing method for manufacturing an electrochemical cell of a polymer matrix battery, comprising the following steps:
a first covering step in which an anode current collector film is covered or impregnated with an anode mixture which is in a pasty or semi-liquid state and which contains at least one anode active material dispersed in a first cross-linkable liquid electrolyte containing a first cross-linkable composition, so as to form an anode electrode;
a second covering step in which a cathode current collector film is covered or impregnated with a cathode mixture which is in a pasty or semi-liquid state and which contains at least one cathode active material dispersed in a second cross-linkable liquid electrolyte containing a second cross-linkable composition, so as to form a cathode electrode;
a third impregnation step during which a separator film, electrically insulating and porous, is impregnated with a third cross-linkable liquid or semi-liquid electrolyte containing a third cross-linkable composition, so as to form a pre-impregnated separator film;
a stacking step during which the anode electrode and the cathode electrode are stacked against each other, by interposing the pre-impregnated separator film, between the anode electrode and the cathode electrode, so as to form a stack;
a solidification step, after the stacking step, during which the stack is exposed to at least one electron beam so that the first cross-linkable liquid electrolyte, the second cross-linkable liquid electrolyte and the third cross-linkable liquid or semi-liquid electrolyte solidify in bulk both in the anode electrode, the cathode electrode and the separator film, thus forming the polymer matrix electrochemical cell.

2. The manufacturing method according to claim 1, wherein the first cross-linkable composition, the second cross-linkable composition and the third cross-linkable composition are similar.

3. The manufacturing method according to claim 1, wherein the first cross-linkable composition, the second cross-linkable composition and the third cross-linkable composition respectively comprise a first monomer or prepolymer mixture, a second monomer or prepolymer mixture and a third monomer or prepolymer mixture, which each comprise monomers or prepolymers or a combination of monomers and prepolymers, wherein the monomers or prepolymers comprise crosslinking functions for solidifying the anode mixture, the cathode mixture and the third cross-linkable liquid or semi-liquid electrolyte upon exposure to the at least one electron beam.

4. The manufacturing method according to claim 3, wherein the crosslinking functions are selected from acrylate, methacrylate, vinyl, styrene, isocyanate, acrylamide and methacrylamide functions.

5. The manufacturing method according to claim 1, wherein the first cross-linkable composition has a mass percentage in the anode mixture, which is comprised between 2 and 20%, and the second cross-linkable composition has a mass percentage in the cathode mixture, which is comprised between 2 and 20%.

6. The manufacturing method according to claim 1, wherein the first covering step implements roll-to-roll deposition or impregnation of the anode mixture onto the anode current collector film such that the anode electrode forms a first continuous strip, the second covering step implements roll-to-roll deposition or impregnation of the cathode mixture onto the cathode current collector film such that the cathode electrode forms a second continuous strip, and the third impregnation step implements continuous impregnation of the separator film with the third cross-linkable liquid or semi-liquid electrolyte such that the pre-impregnated separator film forms a third continuous strip which is interposed between the first continuous strip and the second continuous strip during the stacking step.

7. The manufacturing method according to claim 6, wherein the separator film is continuously unwound from a third coil and continuously impregnated with the third cross-linkable liquid or semi-liquid electrolyte to form the third continuous strip.

8. The manufacturing method according to claim 1, wherein, in the third impregnation step, the third cross-linkable liquid or semi-liquid electrolyte is impregnated in the entire volume of the separator film.

9. The manufacturing method according to claim 1, wherein the stacking step implements a compression of the stack, before exposing it to the at least one electron beam.

10. The manufacturing method according to claim 6, wherein the stacking step implements a compression of the stack, before exposing it to the at least one electron beam, and wherein the compression of the stack is carried out by continuous compression, between two rolling rollers, of the first continuous strip, the third continuous strip and the second continuous strip.

11. The manufacturing method according to claim 1, comprising a final compression step during which the stack is compressed, after having been exposed to the at least one electron beam.

12. The manufacturing method according to claim 1, wherein the anode active material comprises particles of anode active material having maximum dimensions comprised between 0.5 and 200 micrometers, and the cathode active material comprises particles of cathode active material having maximum dimensions comprised between 0.5 and 200 micrometers.

13. The manufacturing method according to claim 12, wherein the particles of anode active material and the particles of cathode active material are particles of spherical or substantially spherical shape.

14. The manufacturing method according to claim 1, wherein the anode mixture contains first electron-conducting charges dispersed in the first cross-linkable liquid electrolyte, and the cathode mixture contains second electron-conducting charges dispersed in the second cross-linkable liquid electrolyte.

15. The manufacturing method according to claim 14, wherein the first electron-conducting charges and the second electron-conducting charges are charges having at least one nanometric dimension between 1 and 200 nanometers.

16. The manufacturing method according to claim 14, wherein the first electron-conducting charges and the second electron-conducting charges are:
carbonaceous charges selected from carbon black, carbon nanofibers, carbon nanofibers coated with titanium nitride, carbon nanotubes, graphene powders, and graphene oxide powders; or
non-carbonaceous charges selected from metal fibers, metal powders such as carbon fluoride powders, aluminum or nickel powders, conductive metal oxides, conductive polymers, and conductive ceramic powders.

17. The manufacturing method according to claim 14, wherein the first electron-conducting charges and the second electron-conducting charges have mass percentages in the respective anode mixture and cathode mixture which are comprised between 0.1 and 10%.

18. The manufacturing method according to claim 1, wherein the first cross-linkable liquid electrolyte and the second cross-linkable liquid electrolyte each comprise at least one lithium or sodium salt dissolved in at least one liquid solvent.

19. The manufacturing method according to claim 1, wherein the first cross-linkable liquid electrolyte and the second cross-linkable liquid electrolyte each comprise at least one surfactant with a mass percentage comprised between 1 and 5%.

20. The manufacturing method according to claim 1, wherein the first covering step implements:
an unwinding of the anode current collector film, which is previously wound on a first coil; and
the covering or the impregnating of the anode current collector film with the anode mixture, as it is unwound.

21. The manufacturing method according to claim 1, wherein the second covering step implements:
an unwinding of the cathode current collector film, which is previously wound on a second coil; and
the covering or the impregnating of the cathode current collector film with the cathode mixture, as it is unwound.

22. The manufacturing method according to claim 1, wherein the first covering step comprises a first thickness calibration step which consists of a mechanical adjustment of a thickness, called first thickness, of the anode electrode before the stacking step.

23. The manufacturing method according to claim 22, wherein the first thickness is adjusted to a value comprised between 10 and 1000 micrometers.

24. The manufacturing method according to claim 22, wherein the first thickness calibration step is implemented by a compression of the anode electrode, before the stacking step.

25. The manufacturing method according to claim 24, wherein the anode electrode is compressed by continuous rolling between two rolling rollers comprising a first input roller and a first output roller.

26. The manufacturing method according to claim 25, wherein the anode current collector film is continuously conveyed into the first input roller, and the anode mixture is deposited or impregnated onto said anode current collector film at said first input roller to form the anode electrode, said anode electrode being continuously conveyed between the first input roller and the first output roller to be compressed and then conveyed out of the first output roller.

27. The manufacturing method according to claim 1, wherein the second covering step comprises a second thickness calibration step which consists of a mechanical adjustment of a thickness, called second thickness, of the cathode electrode.

28. The manufacturing method according to claim 27, wherein the second thickness is adjusted to a value comprised between 10 and 1000 micrometers.

29. The manufacturing method according to claim 27, wherein the second thickness calibration step is implemented by compressing the cathode electrode, before the stacking step.

30. The manufacturing method according to claim 29, wherein the cathode electrode is compressed by continuous rolling between two rolling rollers comprising a second input roller and a second output roller.

31. The manufacturing method according to claim 30, wherein the cathode current collector film is continuously conveyed into the second input roller, and the cathode mixture is deposited or impregnated on said cathode current collector film at said second input roller to form the cathode electrode, said cathode electrode being continuously conveyed between the second input roller and the second output roller to be compressed and then conveyed out of the second output roller.

32. The manufacturing method according to claim 1, wherein, during the solidification step, the stack is exposed to the at least one electron beam which comprises:
a single electron beam facing one of the anode electrode or the cathode electrode, or
two electron beams facing respectively the anode electrode and the cathode electrode.

33. The manufacturing method according to claim 1, wherein the at least one electron beam has an irradiation dose characteristic comprised between 10 and 100 kGy.

34. The manufacturing method according to claim 1, wherein the at least one electron beam has an acceleration voltage characteristic comprised between 100 keV and 1 MeV.

35. The manufacturing method according to claim 1, wherein a scrolling speed of the stack has a speed characteristic comprised between 1 and 500 m/min.

36. The manufacturing method according to claim 1, wherein at least one of the anode current collector film and the cathode current collector film is selected from:
a metal laminated film;
a polymer(s) and metal fibers based-metal composite porous film assembled to form a nonwoven fabric;
a polymer(s) and carbon fibers based-porous carbon composite film assembled to form a nonwoven fabric;
a carbon fibers based-porous film assembled to form a nonwoven fabric.

37. The manufacturing method according to claim 36, wherein the perforations of the metal laminated film have maximum dimensions comprised between 0.5 and 2 millimeters and are distributed with a density comprised between 2 and 10 perforations per cm2.

38. The manufacturing method according to claim 36, wherein the pretreatment comprises depositing on the carbon fibers a pretreatment layer based on titanium nitride or titanium carbide or titanium nitride and carbide, said pretreatment layer having a thickness comprised between 100 and 1000 nanometers.

39. The manufacturing method according to claim 1, wherein the anode current collector film comprises an inner anode face on which the anode mixture is deposited or impregnated during the first covering step, and an outer anode face, opposite the inner anode face, where said outer anode face is covered or impregnated beforehand with a layer of conductive varnish which is leak-tight and electrically conductive;
and the cathode current collector film comprises an inner cathode face on which the cathode mixture is deposited or impregnated during the second covering step, and an outer cathode face, opposite the inner cathode face, where said outer cathode face is covered or impregnated beforehand with another layer of conductive varnish which is leak-tight and electrically conductive.

40. The manufacturing method according to claim 39, wherein the layer of conductive varnish and the other layer of conductive varnish each have a thickness less than or equal to 30 micrometers.

41. The manufacturing method according to claim 1, wherein the first covering step and the second covering step are carried out in parallel.

42. The manufacturing method according to claim 1, wherein the stack has two opposite longitudinal edges, and the manufacturing method comprises a step of applying electrically insulating varnish, after the stacking step and before the solidification step, during which two layers of electrically insulating varnish, electrically insulating and leak-tight, are deposited respectively on the two opposite longitudinal edges of the stack.

43. The manufacturing method according to claim 42, wherein the two layers of electrically insulating varnish harden upon exposure to the at least one electron beam during the solidification step.

44. The manufacturing method according to claim 42, wherein the anode current collector film has two opposite longitudinal edges defining between them a width of the anode current collector film, and the anode mixture is deposited or impregnated on said anode current collector film, during the first covering step, to form a strip having a width less than the width of the anode current collector film, thus leaving the two longitudinal edges of the anode current collector film uncovered and unimpregnated with the anode mixture,
the cathode current collector film has two opposite longitudinal edges defining between them a width of the cathode current collector film, and the mixture cathode is deposited or impregnated on said cathode current collector film, during the second covering step, to form a strip having a width less than the width of the cathode current collector film, thus leaving the two longitudinal edges of the cathode current collector film uncovered and unimpregnated with the cathode mixture,
so that the two opposite longitudinal edges of the stack are free of the anode mixture and the cathode mixture before the step of applying the electrically insulating varnish.

45. The manufacturing method according to claim 1, wherein the active anode material is selected from anode materials, used alone or in combination, based on:
carbon,
silicon,
carbonaceous silicon or lithiated silicon,
transition metals or alloys of transition metals,
composite materials combining transition metals and carbon,
lithium metal,
sodium metal,
lithium titanate,
aluminum, or magnesium, or tin, or zinc.

46. The manufacturing method according to claim 1, wherein the active cathode material is selected from cathode materials, used alone or in combination, based on:
lithiated Nickel Manganese Cobalt,
lithiated Nickel Cobalt Aluminum,
lithiated Iron Phosphate,
lithiated Lithium Cobalt Oxide,
lithiated Manganese Oxide,
sulfur-carbon composite in the presence of a lithiated anode material,
lithium sulfide,
sodium alloy.

47. The manufacturing method according to claim 1, wherein the first covering step, the second covering step, the stacking step and the solidification step are carried out in an anhydrous atmosphere.

48. An installation for manufacturing an electrochemical cell of a polymer matrix battery, comprising the following stations:
a first covering station comprising a first distributor of an anode current collector film, a first reservoir containing an anode mixture which is in a pasty or semi-liquid state and which contains at least one anode active material dispersed in a first cross-linkable liquid electrolyte containing a first cross-linkable composition, and a first covering unit for covering or impregnating the anode current collector film with the anode mixture so as to form an anode electrode;
a second covering station comprising a second distributor of a cathode current collector film, a second reservoir containing a cathode mixture which is in a pasty or semi-liquid state and which contains at least one cathode active material dispersed in a second cross-linkable liquid electrolyte containing a second cross-linkable composition, and a second covering unit for covering or impregnating the cathode current collector film with the cathode mixture so as to form a cathode electrode;
a third impregnation station comprising a third distributor of a separator film, electrically insulating and porous, and an impregnation unit for impregnating the separator film with a third cross-linkable liquid or semi-liquid electrolyte so as to form a pre-impregnated separator film;
a stacking station for stacking the anode electrode and the cathode electrode, with an interposition of the pre-impregnated separator film between the anode electrode and the cathode electrode, to form a stack;
a solidification station, at the outlet of the stacking station, comprising at least one electron beam generator for exposing said stack to at least one electron beam so that the first cross-linkable liquid electrolyte, the second cross-linkable liquid electrolyte and the third cross-linkable liquid or semi-liquid electrolyte solidify in bulk both in the anode electrode, the cathode electrode and the separator film, thus forming the polymer matrix electrochemical cell.
